(19) United States
(12) Patent Application Publication
(10) Pub. No.: US 2021/0340807 A1
(43) Pub. Date: Nov. 4, 2021

(54) Moveable Bar Countertop Partition for the Hygienic Separation of Patrons

(71) Applicants: Edward Carl Pelger, Lititz, PA (US); Michael Anthony Owens, Lancaster, PA (US)

(72) Inventors: Edward Carl Pelger, Lititz, PA (US); Michael Anthony Owens, Lancaster, PA (US)

(21) Appl. No.: 17/078,259

(22) Filed: Oct. 23, 2020

Related U.S. Application Data
(60) Provisional application No. 63/101,414, filed on Apr. 30, 2020.

(51) Int. Cl. E05G 7/00; A47F 9/00

(52) U.S. Cl. CPC E05G 7/00; A47F 9/00

(57) ABSTRACT

A moveable partition for the hygienic separation of patrons or customers particularly suited for use on bar countertops consisting of a transparent sheet of plastic of appropriate size vertically supported atop the countertop by a counterweight mounted at one end of the sheet, the counterweight end to be positioned at the inner side of the bar top, the counterweight optionally detachable from the sheet, optionally providing a handle to position the partition, and optionally raising the sheet to a selected height over a bar countertop having an outer lip to provide for the positioning of the sheet between patrons.

### CROSS REFERENCE TO RELATED APPLICATIONS

This application is based on the disclosure of U.S. Provisional Application No. 63/101,414 filed Apr. 30, 2020 by the same inventors which disclosure is herein incorporated by reference.

### BACKGROUND OF THE INVENTION

### Field of the Invention

The invention resides in the field of space divisions and more particularly relates to partitions to prevent the spread of airborne infections in public establishments such as bars and restaurants.

### Description of the Prior Art

The use of protective devices composed of transparent plastic rigid sheets to prevent or minimize the airborne transfer of germs is known in the prior art. Sneeze guards at many restaurant salad bars are an example. The patron has the ability to look through the transparent plastic but the particles that are expelled by their breathing or sneezing are substantially blocked by the sneeze guard thereby protecting food from the airborne germs emitted by a customer.

Also cafeteria food lines often have transparent, rigid plastic barriers or shields to limit germs spread from patrons to the food, while still allowing the patrons to see what they are selecting.

In recent times, due to the COVID-19 pandemic, convenience stores, pharmacies, grocery stores and other stores have started to install transparent, plastic sheets, rigidly attached and immovable to create a degree of separation between service workers and customers.

The inventors are unaware of any prior art structures which embody the novel features of the moveable partition of this disclosure.

### SUMMARY OF THE INVENTION

The invention may be summarized as a moveable partition for the hygienic separation of patrons or customers particularly suited for use on bar countertops consisting of a transparent sheet of plastic of appropriate size vertically supported atop the countertop by a counterweight mounted at one end of the sheet. In use, the counterweight end will be positioned at the inner side of the bar top. The counterweight may be detachable from the sheet, may provide a handle to position the partition, and may raise the sheet to a selected height over a bar countertop having an outer lip to provide for the positioning of the sheet between patrons.

With the heightened concern for airborne pathogens brought about by the COVID-19 pandemic, the way restaurants and bars are utilized will change. The desire to keep physical distance between unknown people will necessitate that many bar stools will be left empty between patrons. For example, a bar with thirty seats may now only be able to sit six customers when physical distancing guidelines are followed.

Standing in lines inside a restaurant while waiting for a table or bar seat will no longer be a normal practice. Customers will likely contact the restaurant, then wait outside or in their cars until the area has been set up for the customer or group of customers. There will be much more of a focus on preventing customer to customer germ transmission.

If permanently attached transparent plastic barriers were added between each bar stool, customers that came in as a group, for example, a family of four people, would not be able to easily talk with each other, making the bar experience much less desirable.

Features of the invention include:

A means to provide hygienic separation between customers at a bar to provide a better experience for customers in a group and provide better facility utilization for the establishment.

A more efficient cleaning process, as is required between customers, will result due to the relatively light weight of the moveable partition and facilitate cleaning underneath the area of the device.

The counterweight design will keep the partition from easily toppling over without the need for projecting legs or supports which would make cleaning and storage more difficult.

In addition to the hand cleaning between each group of customers, these partitions can also be easily cleaned as a group by carrying them outside and spraying them with a hose and disinfectant.

The weight of a single partition may be selected to be in accordance with insurance guidelines for lifting weights for establishment employees.

The bar countertop may be protected from scratches by a layer of cushioning material positioned underneath the partition counterweight.

The details of the structure of the invention will be more fully understood from the following description of the preferred embodiment accompanied by the drawings.

### DESCRIPTION OF THE DRAWINGS

FIG. 1 is a perspective view of a preferred embodiment of the invention;

FIG. 2 is an elevational side view of the of the embodiment of FIG. 1;

FIG. 3 is a top view of the embodiment of FIG. 1;

FIG. 4 is a bottom view of the embodiment of FIG. 1;

FIG. 5 is a rear view of the embodiment of FIG. 1;

FIG. 6 is a cross sectional illustration of a portion of the embodiment of FIG. 1 along line A-A; and

FIG. 7 is a further illustration of the embodiment of FIG. 1 in use.

### DESCRIPTION OF THE PREFERRED EMBODIMENT

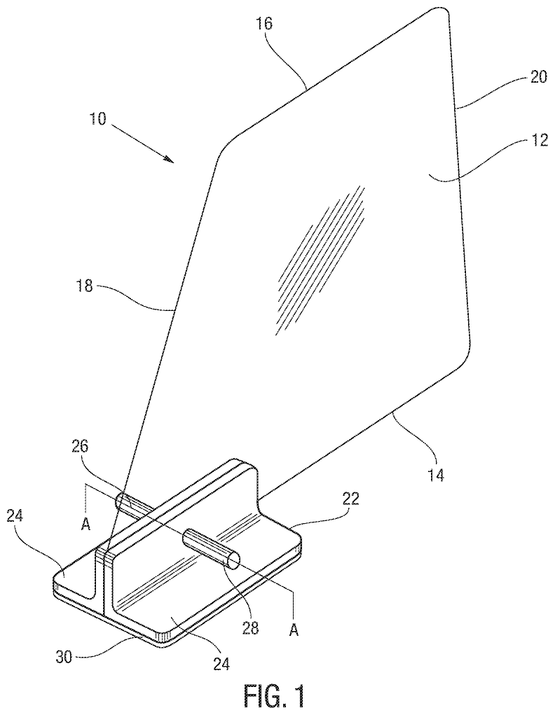

Referring to FIG. 1, a perspective illustration of a preferred embodiment of the invention 10 is shown in which a transparent sheet of, for example, a polycarbonate or similar plastic material 12, having a lower edge 14, an upper edge 16, a rear edge 18 and a forward edge 20, is supported by an exemplary counterweight 22 attached to the sheet at the location of the intersection of its lower and rear edges, the counterweight supporting sheet 12 in an upright position when placed on a bar top. The combined weight of the counterweight and sheet are selected to be within any governmental or insurance requirements relating to liftable weight limitations by employees.

Counterweight 22 is composed of a pair of opposed right angle metal members 24 and is arranged to support and clamp sheet 12 when engaged by a clamping assembly comprising a pair of opposed threaded handles 26 and 28 more specifically shown in FIG. 6. A countertop protective mat 30 is positioned on the underside of right angle members 24.

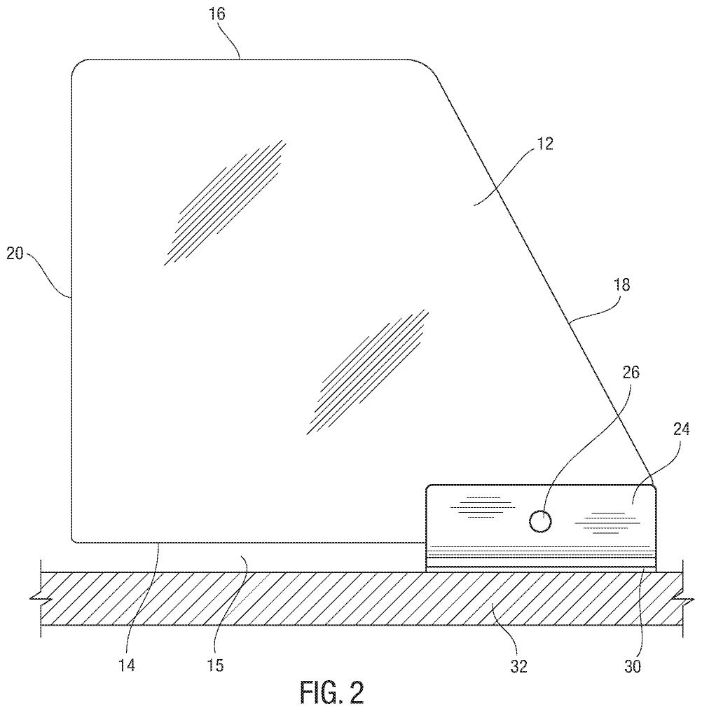

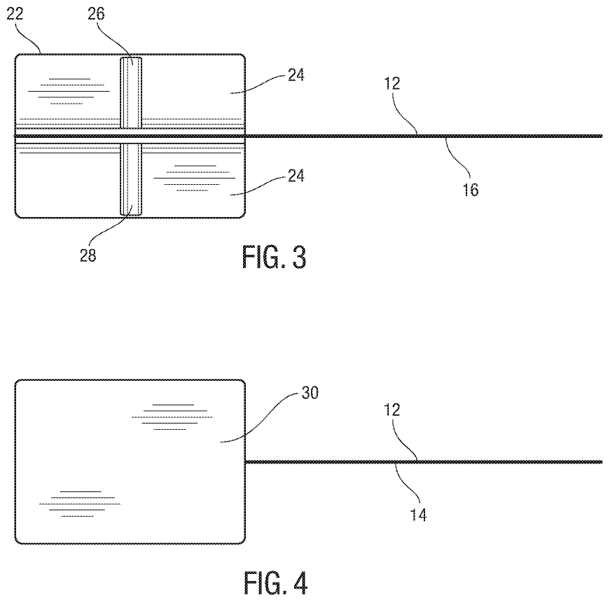

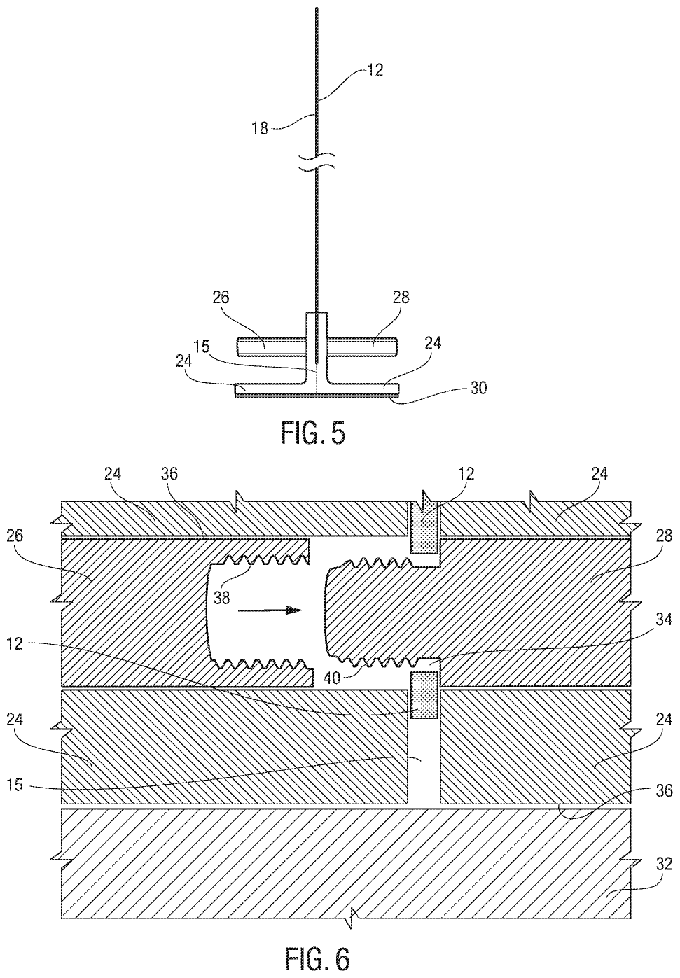

FIGS. 2-5 are additional views of the partition of FIG. 1 wherein like callout designations refer to that Figure. FIG. 2 further shows sheet 12 with a space 15 above a countertop 32 as is achieved by the configuration of the clamping assembly.

FIG. 6 is a cross sectional illustration wherein sheet 12 and right angle members 24 each have aligned holes 34 and 36 respectively positioned transverse partition 10 and the clamping assembly comprises a pair of opposing female 38 and male 40 mutually communicating threads at the ends of members 26 and 28 respectively disposed in holes 34 and 36 respectively, the threaded members serving to clamp sheet 12 between right angle members 24 when the threaded members are engaged.

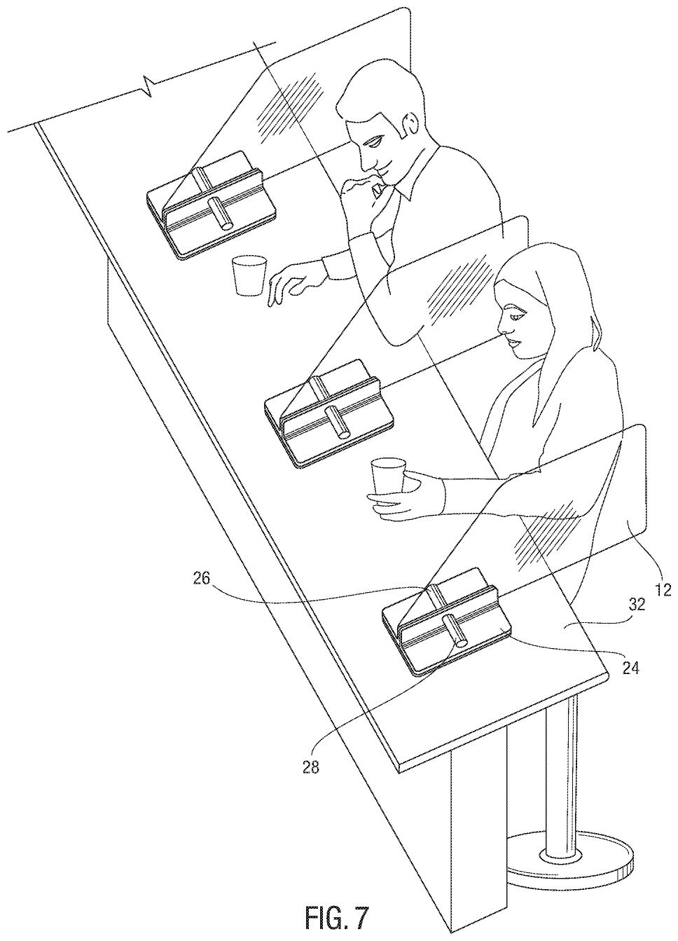

FIG. 7 illustrates the invention in use.

It will be understood that both the shape and material of sheet 12 and the configuration of counterweight 22 may be altered to achieve the protective function of the invention within the scope of and as defined by the following claims.

What is claimed is:

1. A moveable bar countertop partition for the hygienic separation of patrons, said bar countertop having an inner side and an outer side, said partition comprising in combination:
A. a transparent sheet of plastic, said sheet having a lower edge and an upper edge, a rear edge and a forward edge, said sheet configured to be positioned transversely across said bar, said rear edge of said sheet commensurate with said inner side of said bar and said forward edge of said sheet extending beyond said outer side of said bar a sufficient distance to separate said patrons from physical contact; and
B. a counterweight attached to said sheet at the location of the intersection of said lower edge and said rear edge of said sheet, said counterweight arranged to support said sheet in an upright position.

2. The partition of claim 1 including a countertop protective mat disposed beneath said counterweight.

3. The partition of claim 1 wherein said counterweight is comprised of a pair of opposed right angle members and a clamping assembly to clamp said sheet between said members in said upright position.

4. The partition of claim 3 wherein said sheet and said right angle members each have an aligned hole transverse said partition and said clamping assembly comprises a pair of opposing male and female mutually communicating threaded members disposed in said holes, said threaded members arranged to clamp said sheet between said right angle members when said threaded members are engaged.

5. The partition of claim 4 wherein said threaded members comprise handles for said partition.
